(19) United States
(12) Patent Application Publication
(10) Pub. No.: US 2025/0226710 A1
(43) Pub. Date: Jul. 10, 2025

(54) MOTOR

(71) Applicant: SUBARU CORPORATION, Tokyo (JP)

(72) Inventor: Kazuyuki AOKI, Tokyo (JP)

(21) Appl. No.: 18/974,941

(22) Filed: Dec. 10, 2024

(30) Foreign Application Priority Data
Jan. 9, 2024 (JP) 2024-001536

(51) Int. Cl. H02K 1/2791; H02K 9/02

(52) U.S. Cl. CPC H02K 1/2791; H02K 9/02

(57) ABSTRACT

A motor includes a stator, a rotor, and a magnet. The rotor is configured to rotate relative to the stator. The magnet is provided for the rotor while facing the stator. The magnet has, at least inside the magnet, a space in which a heating medium is capable of flowing.

### CROSS-REFERENCE TO RELATED APPLICATIONS

The present application claims priority from Japanese Patent Application No. 2024-001536 filed on Jan. 9, 2024, the entire contents of which are hereby incorporated by reference.

### BACKGROUND

The disclosure relates to a motor.

For example, Japanese Unexamined Patent Application Publication (JP-A) No. 2018-207691 discloses a rotary electrical machine (motor) including a stator frame for fixing a stator, and the stator frame is formed by additive manufacturing. In JP-A No. 2018-207691, the stator frame has a flow passage in which refrigerant flows. In JP-A No. 2018-207691, the stator can be cooled through the stator frame by causing the refrigerant to flow in the flow passage of the stator frame.

### SUMMARY

An aspect of the disclosure provides a motor including a stator, a rotor, and a magnet. The rotor is configured to rotate relative to the stator. The magnet is provided for the rotor while facing the stator. The magnet has, at least inside the magnet, a space in which a heating medium is capable of flowing.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is an exploded view of a motor according to an embodiment of the disclosure;

FIG. 2 is a perspective view illustrating one example of the configuration of a magnet;

FIG. 3 illustrates the one example of the configuration of the magnet when the inside is seen through;

FIG. 4 is a partial enlarged view illustrating one example of the inside of the magnet;

FIG. 5 is a partial enlarged view of the inside of a magnet of one modification;

FIG. 6 is a partial enlarged view of the inside of a magnet of another modification;

FIG. 7 illustrates the inside of a magnet of another modification when seen through;

FIG. 8 is a perspective view of a magnet of an alternative modification when viewed from the side of an outer peripheral surface;

FIG. 9 is a perspective view of the magnet of the alternative modification when viewed from the side of a facing surface;

FIG. 10 is a sectional view of the magnet of the alternative modification; and

FIG. 11 is a perspective view illustrating one example of the configuration of a rotor of a motor of a modification.

### DETAILED DESCRIPTION

A rotor of a motor is sometimes provided with a magnet. In such a motor, the magnet may be degraded in performance when the temperature of the magnet of the rotor is relatively increased due to heat generation of the motor. For this reason, it is desirable to suppress temperature increase of the magnet.

Thus, it is desirable to provide a motor capable of suppressing temperature increase of a magnet.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

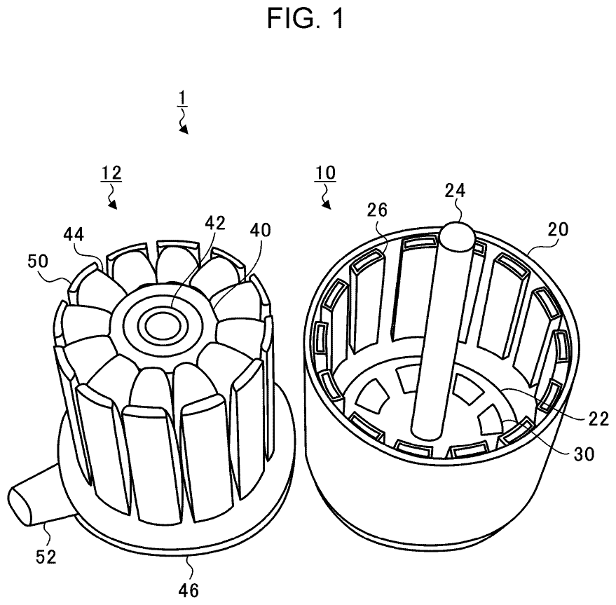

FIG. 1 is an exploded view of a motor 1 according to the present embodiment. The motor 1 of the present embodiment includes a rotor 10 and a stator 12. In FIG. 1, the stator 12 is separated from the rotor 10. Although detailed description will be given later, the motor 1 is, for example, an outrunner (in other words, outer-rotor) motor in which the rotor 10 is disposed on the outer side relative to the stator 12.

The rotor 10 includes a rotor body 20, a first flange 22, a rotating shaft 24, and a magnet 26. The rotor body 20 has a hollow cylindrical shape. The first flange 22 is coupled to an end portion, on one side, of the hollow cylindrical rotor body 20. An end portion of the rotor body 20 on the side opposite from the first flange 22 is open with the stator 12 being separated from the rotor 10.

The first flange 22 has, for example, a circular flat plate shape. At least part of the first flange 22 may have a through hole 30 passing through the first flange 22. By providing the through hole 30, smooth circulation of air between the inside and the outside of the rotor 10 can be achieved.

The rotating shaft 24 is disposed inside the rotor body 20 so as to overlap the central axis of the rotor 10. That is, the axial direction of the rotating shaft 24 is substantially the same as the axial direction of the rotor 10. An axial end portion of the rotating shaft 24 on one side is coupled to the first flange 22. The rotating shaft 24 and the first flange 22 are formed, with the rotor body 20, into one body and are rotatable in synchronism with the rotation of the rotor body 20.

The magnet 26 is, for example, a permanent magnet. The magnet 26 has the shape of a piece of a circumferentially divided ring. Multiple magnets 26 are provided on an inner surface of the rotor body 20 and are supported by the rotor body 20. While provided on the inner surface of the rotor body 20, the magnets 26 are disposed in the circumferential direction of the rotor body 20 so as to form an approximate ring shape. Adjacent ones of the magnets 26 are separated from each other. The magnet 26 will be described in detail later.

The stator 12 includes a stator body 40, a bearing 42, a coil 44, and a second flange 46. The stator body 40 has an approximately cylindrical shape whose outside diameter is smaller than the inside diameter of the rotor body 20.

The bearing 42 is provided at the center of the stator body 40 in a radial direction of the stator body 40. The rotating shaft 24 of the rotor 10 is insertable inside the bearing 42.

Multiple teeth 50 are formed on the outer periphery of the stator body 40 and protrude outward in the radial direction of the stator body 40. The coil 44 is wound around each of the teeth 50.

The second flange 46 is provided on an axial end portion of the stator body 40 on one side. The second flange 46 supports the stator body 40. A wire 52 coupled to the coil 44 is extended from the second flange 46.

The motor 1 is assembled in such a way that the rotating shaft 24 is inserted in the bearing 42, and the stator body 40 is accommodated inside the rotor body 20. An opening of the end portion of the rotor body 20 before assembly of the motor 1 is covered by the second flange 46 after the assembly. The rotor body 20 and the stator body 40 are positioned between the first flange 22 and the second flange 46 after the assembly.

In the motor 1 after the assembly, the magnets 26 of the rotor 10 and the teeth 50 of the stator 12 are concentrically disposed, and the magnets 26 face the teeth 50. Since the coil 44 is wound around the teeth 50 as described above, the magnets 26 substantially face the coil 44. Each of the magnets 26 and a corresponding one of the teeth 50 are separated with a separation distance therebetween. The separation distance is short but prevents contact between each of the magnets 26 and a corresponding one of the teeth 50. The separation distances between the magnets 26 and the teeth 50 are approximately uniform along the circumferential direction of the rotor.

When an AC power is supplied to the coil 44 of the stator 12, a rotating magnetic field is generated at the stator 12. With the rotation of the rotating magnetic field, the rotor 10 rotates, about the rotating shaft 24, relative to the stator 12.

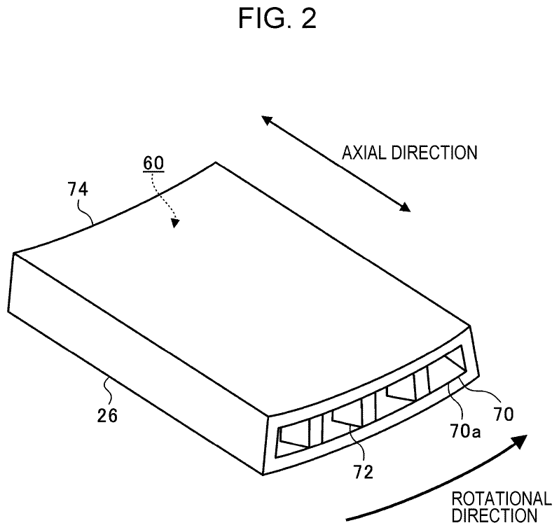

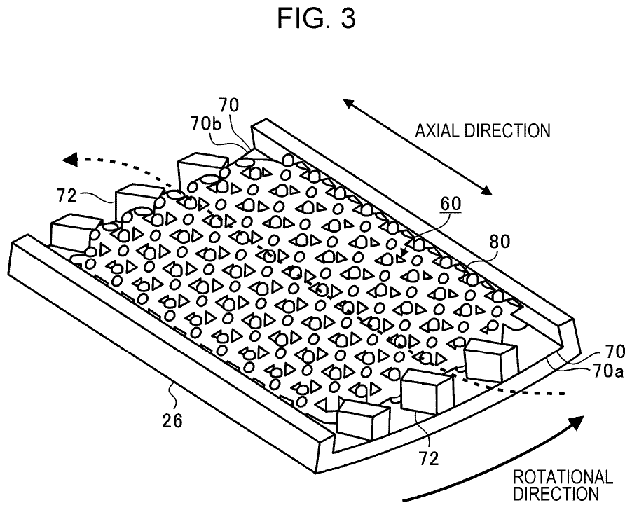

FIG. 2 is a perspective view illustrating one example of the configuration of the magnet 26. FIG. 3 illustrates the one example of the configuration of the magnet 26 when the inside is seen through. Note that the “axial direction” in the figure means the axial direction of the rotor 10, that is, the axial direction of the rotating shaft 24, and the “rotational direction” in the figure means the rotational direction of the rotor 10, that is, the rotational direction of the magnet 26.

As illustrated in FIGS. 2 and 3, a space 60 in which a heating medium can flow is intentionally formed inside the magnet 26. The heating medium is, for example, air but may be any fluid enabling the heat inside the magnet 26 to transfer. A method of forming the space 60 will be described in detail later.

As illustrated in FIGS. 2 and 3, the magnet 26 includes a first opening part 70a and a second opening part 70b. Hereinafter, the first opening part 70a and the second opening part 70b are each sometimes collectively referred to as an opening part 70.

The first opening part 70a is provided in an end face of the magnet 26 on one side in the axial direction of the rotor 10. The second opening part 70b is provided in an end face of the magnet 26 on the other side in the axial direction of the rotor 10. The opening part 70 allows a communication between the space 60 inside the magnet 26 and the outside of the magnet 26.

As the broken-line arrow in FIG. 3 indicates, in the motor 1, air, which is one example of the heating medium, can be introduced into the space 60 inside the magnet 26 from the outside of the magnet 26 through the first opening part 70a. In addition, in the motor 1, air, which is one example of the heating medium, can be delivered outside the magnet 26 from the space 60 inside the magnet 26 through the second opening part 70b.

As described above, the motor 1 of the present embodiment enables the heating medium to flow in the space 60 inside the magnet 26. Thus, the motor 1 of the present embodiment can suppress, from the inside of the magnet 26, temperature increase of the magnet 26 by causing the heating medium to flow. Consequently, the motor 1 of the present embodiment can suppress performance degradation of the magnet 26.

Since the motor 1 of the present embodiment can suppress, from the inside of the magnet 26, temperature increase of the magnet 26, the motor 1 can enhance the temperature suppression effect of the magnet 26 compared with a form intended for suppressing, from a surface of the magnet 26, temperature increase of the magnet 26.

Note that the above-described form including both the first opening part 70a and the second opening part 70b is one option, and, for example, the first opening part 70a may simply be provided. Even with one opening part 70, the heating medium can flow between the space 60 inside the magnet 26 and the outside of the magnet 26 through the opening part 70. Thus, the temperature suppression effect of the magnet 26 can be enhanced compared with a form intended for suppressing, from a surface of the magnet 26, temperature increase of the magnet 26.

In addition, the position of the opening part 70 is not limited to such a position in an end face of the magnet 26 in the axial direction of the rotor 10. In one example, in a form in which adjacent ones of the magnets 26 are separated from each other, the opening part 70 may be provided in a circumferential end face of the magnet 26. In this example, the heating medium can also move between the inside and the outside of the magnet 26 through the opening part 70, and temperature increase of the magnet 26 can be suppressed.

As illustrated in FIGS. 2 and 3, the magnet 26 includes a fin 72. The fin 72 may be made of a magnetic material, as part of the magnet 26. The fin 72 is provided in the opening part 70. In the example in FIGS. 2 and 3, three fins 72 are provided in the first opening part 70a, and three fins 72 are provided in the second opening part 70b. Note that the number of the fins 72 in one opening part 70 is not limited to the number given as an example and may be set to any number.

The fin 72 extends from the opening part 70 in a direction inclined to the axial direction of the rotor 10. For example, in the first opening part 70a, each of the fins 72 extends so as to be inclined in a direction opposite to the rotational direction of the magnet 26 from an end face of the first opening part 70a of the magnet 26 toward the inside of the magnet 26. In the second opening part 70b, each of the fins 72 extends so as to be inclined in the direction opposite to the rotational direction of the magnet 26 from the inside of the magnet 26 toward an end face of the second opening part 70b of the magnet 26.

When the magnet 26 rotates in the rotational direction, the heating medium near the first opening part 70a is gathered and drawn from the first opening part 70a into the magnet 26 by the fins 72 in the first opening part 70a. Thus, the motor 1 can achieve smoother introduction of the heating medium into the magnet 26.

In addition, when the magnet 26 rotates in the rotational direction, the heating medium near the fins 72 in the second opening part 70b slides outside the magnet 26 by the fins 72 in the second opening part 70b. Thus, the motor 1 can achieve smoother delivery of the heating medium to the outside of the magnet 26.

The surface area of the magnet 26 is increased by providing the fin 72, and heat radiation of the fin 72 itself can also suppress temperature increase of the magnet 26.

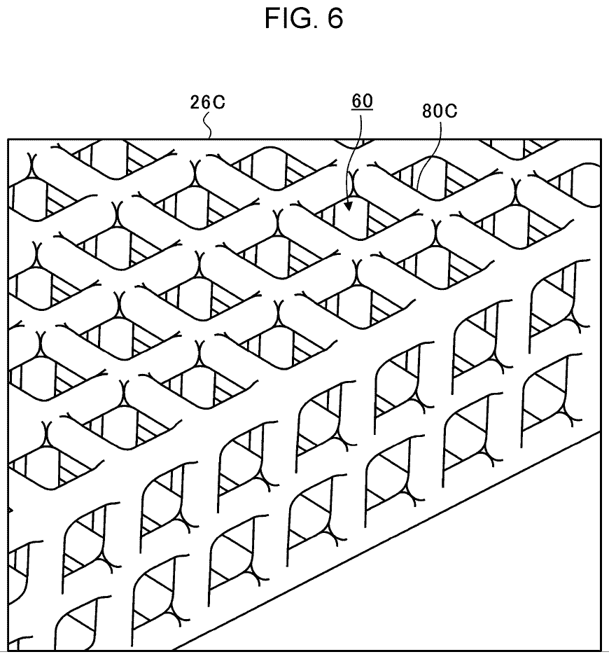

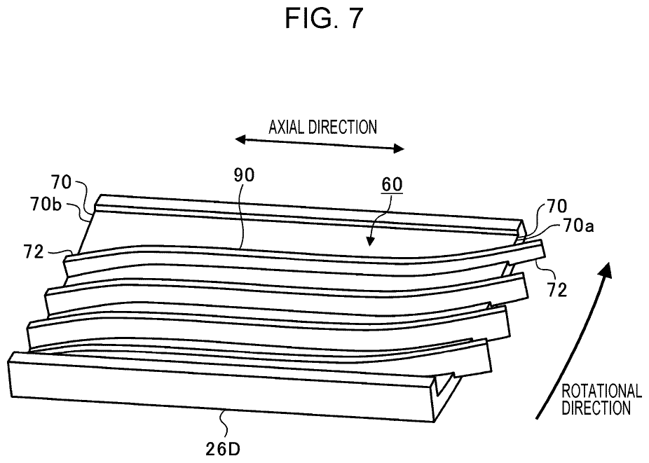

Note that such a form in which the fins 72 are provided in both the first opening part 70a and the second opening part 70b is one option, and, in one example, the fin 72 may be provided in any one of the first opening part 70a and the second opening part 70b. In this example, smooth movement of the heating medium inside and outside the magnet 26 can also be achieved. In addition, the fin 72 may be omitted in both the first opening part 70a and the second opening part 70b. Moreover, as in an example of the fin 72 in FIG. 7, which will be described later, at least part of the fin 72 may protrude outside from an end face of the magnet 26.

As illustrated in FIG. 2, the magnet 26 includes a facing surface 74 facing the coil 44 of the stator 12. For example, since the motor 1 is an outrunner motor, the facing surface 74 of the magnet 26 is an inner surface corresponding to an inner peripheral surface of the ring formed by the magnets 26.

As illustrated in FIG. 2, the facing surface 74 covers the space 60 inside the magnet 26. In other words, in the magnet 26, the space 60 inside the magnet 26 is not exposed at the facing surface 74, and density reduction of the material of the magnet 26 at the facing surface 74 can be suppressed.

Here, the facing surface 74 of the magnet 26 serves as the north or south magnetic pole. In the motor 1, since density reduction of the material can be suppressed at the facing surface 74 serving as the magnetic pole, magnetic reduction due to the magnet 26 can be suppressed. Consequently, reduction in the output of the motor 1 can be suppressed.

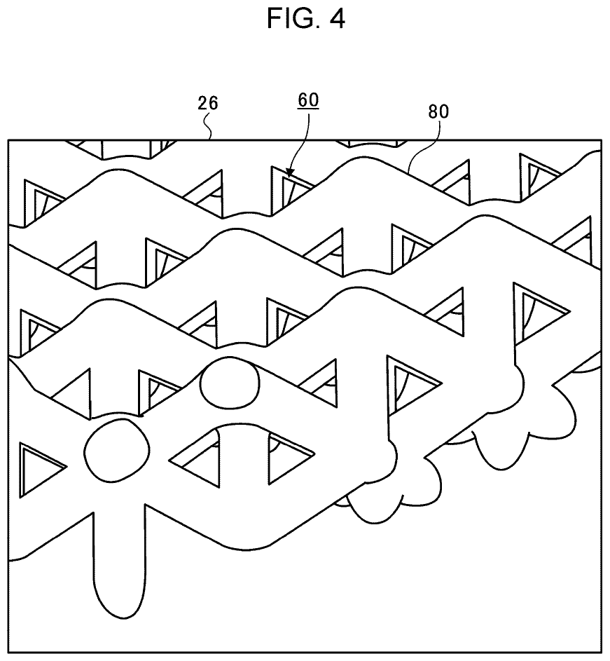

FIG. 4 is a partial enlarged view illustrating one example of the inside of the magnet 26. As illustrated in FIG. 4, the magnet 26 includes a lattice structure part 80 thereinside. That is, the space 60 inside of the magnet 26 is formed by forming the inside structure of the magnet 26 into a lattice structure. The lattice structure part 80 is made of a magnetic material, as part of the magnet 26. Note that the lattice structure is a structure formed by disposing branched lattices regularly into a three-dimensional object. The magnet 26 including the lattice structure part 80 may be manufactured by, for example, additive manufacturing, that is, 3D printing.

In the motor 1 of the present embodiment, by providing the lattice structure part 80 inside the magnet 26, the space 60 can be formed inside the magnet 26 such that the magnetism of the magnet 26 can be maintained while reduction in the strength of the magnet 26 can be suppressed.

As illustrated in FIG. 4, the lattice structure part 80 may be formed by disposing body-centered cubic lattices regularly. Note that such a body-centered cubic lattice is a lattice in which nodes are disposed at vertices and the center of a cubic unit cell.

By adopting the body-centered cubic lattice as the lattice structure of the lattice structure part 80, the magnetism of the magnet 26 can be maintained while the space 60 inside the magnet 26 can be ensured, and reduction in the strength of the magnet 26 can be suppressed suitably.

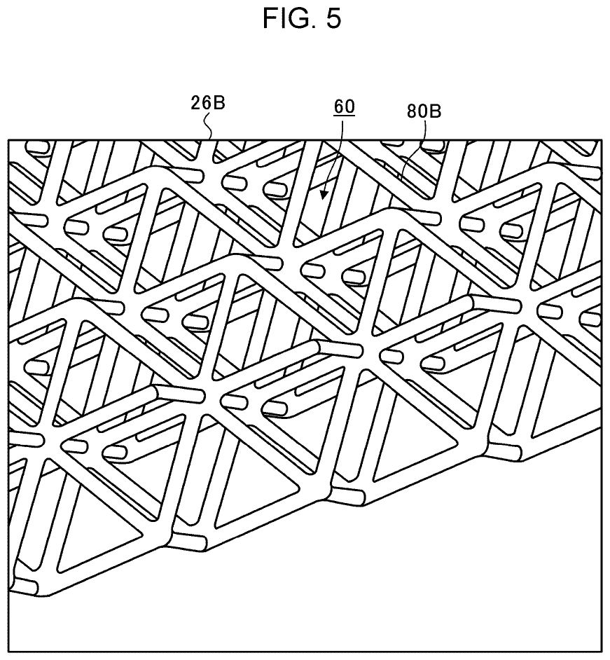

FIG. 5 is a partial enlarged view of the inside of a magnet 26B of one modification. The lattice shape of a lattice structure part 80B illustrated in FIG. 5 is a body-centered cubic lattice as in FIG. 4. However, in FIG. 5, the thickness of a line between nodes, that is, the thickness of a lattice is smaller than that of the example in FIG. 4.

In the lattice structure part 80B whose lattice thickness is relatively small, the strength of the inside of the magnet 26B may be reduced compared with the lattice structure part 80 whose lattice thickness is relatively large. However, as the lattice thickness decreases, the volume of the space 60 inside the magnet 26B can be increased. In that way, the heating medium easily flows inside the magnet 26B, and efficient temperature suppression of the magnet 26B can be achieved.

That is, during the development or the manufacturing of the motor 1, the lattice thickness of the lattice structure part 80 may be set appropriately in view of the strength of the magnet 26 and the flowability of the heating medium.

FIG. 6 is a partial enlarged view of the inside of a magnet 26C of another modification. As illustrated in FIG. 6, a lattice structure part 80C may be formed by disposing orthogonal lattices regularly. Note that such an orthogonal lattice is a lattice in which nodes are disposed at vertices of a cubic unit cell.

In the orthogonal lattice, the number of lines between the nodes of the unit cell is fewer than that of the body-centered cubic lattice, and the strength of the inside of the magnet 26C may be reduced. However, the space 60 inside the magnet 26C can have a linear shape in the orthogonal lattice, compared with the body-centered cubic lattice. In that way, by adopting the orthogonal lattice as the lattice structure, the heating medium easily flows inside the magnet 26C compared with the body-centered cubic lattice. Thus, temperature increase of the magnet 26C can be suppressed efficiently.

That is, during the development of the manufacturing of the motor 1, the lattice shape of the lattice structure part 80 may be set appropriately in view of the strength of the magnet 26 and the flowability of the heating medium.

Note that the lattice structure is not limited to the body-centered cubic lattice and the orthogonal lattice in the above examples and may be any lattice shape such as a face-centered cubic lattice.

Up to here the examples in which the space 60 is formed inside the magnet 26 by forming the inside structure of the magnet 26 into a lattice structure have been described. However, the space 60 may be formed throughout the magnet 26 by forming, for example, the entire magnet 26, not the inside of the magnet 26 alone, into a lattice structure. That is, the magnet 26 may have, at least thereinside, the space 60 in which the heating medium can flow. This form can also suppress, from the inside of the magnet 26, temperature increase of the magnet 26 by using a flow of the heating medium.

FIG. 7 illustrates the inside of a magnet 26D of another modification when seen through. As illustrated in FIG. 7, the magnet 26D includes a partition plate 90.

The partition plate 90 is made of a magnetic material, as part of the magnet 26D. The partition plate 90 stands in a radial direction crossing the axial direction and the rotational direction of the magnet 26D. The partition plate 90 extends in the axial direction of the magnet 26D. For example, the side of the partition plate 90 closer to the first opening part 70a is continuous to the fin 72 in the first opening part 70a. The side of the partition plate 90 closer to the second opening part 70b is continuous to the fin 72 in the second opening part 70b.

Although FIG. 7 illustrates an example including four partition plates 90, the number of the partition plates 90 is not limited to four and may be any number as long as the space 60 can be formed suitably.

Each space 60 is formed inside the magnet 26D by using, of the magnet 26D, the facing surface 74, an outer surface opposite from the facing surface 74, and the circumferential end faces, and the partition plates 90. The heating medium introduced into the magnet 26D is guided by the partition plates 90 and is moved axially. The magnet 26D of this modification can also suppress, from the inside of the magnet 26D, temperature increase of the magnet 26D.

As described above, the inside structure of the magnet 26 is not limited to a lattice structure and may be, for example, a structure with the partition plate 90 as in FIG. 7 as long as the structure allows the heating medium to flow inside the magnet 26 suitably.

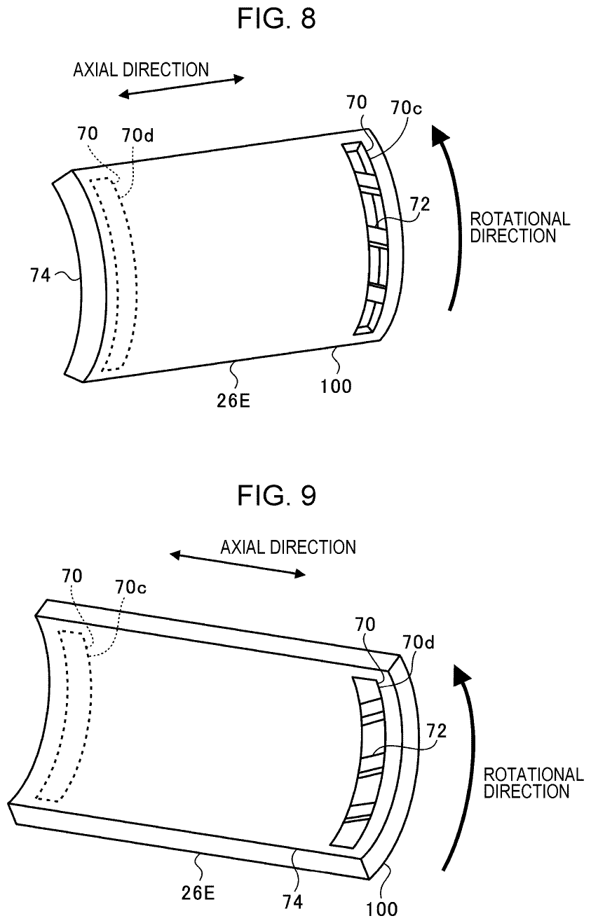

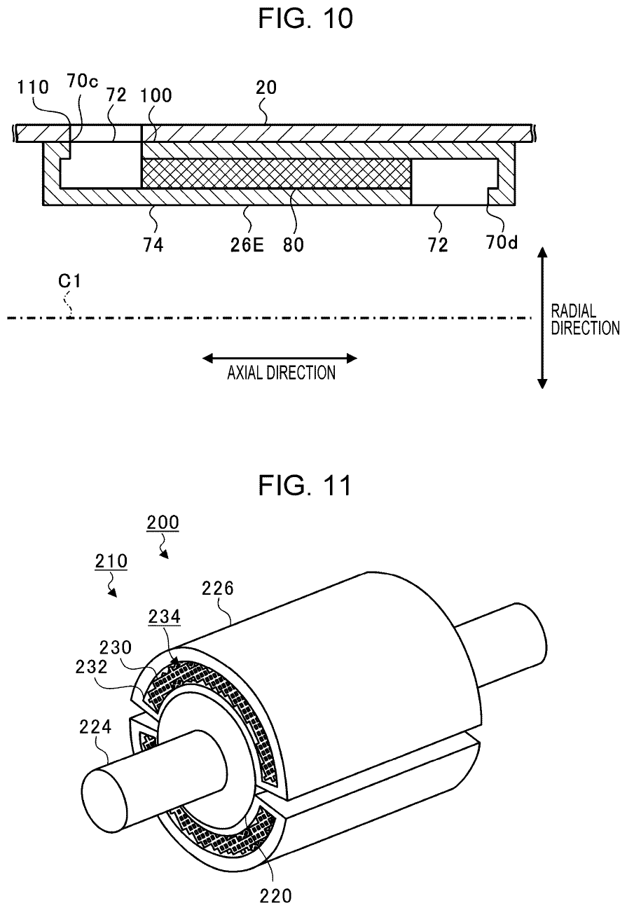

FIG. 8 is a perspective view of a magnet 26E of an alternative modification when viewed from the side of an outer peripheral surface 100. FIG. 9 is a perspective view of the magnet 26E of the alternative modification when viewed from the side of the facing surface 74. FIG. 10 is a sectional view of the magnet 26E of the alternative modification. Note that, in FIG. 10, the lattice structure part 80 is illustrates by cross-hatching in a simple manner for convenience. In addition, the dot-and-dash line C1 in FIG. 10 represents the central axis of the rotor 10.

As illustrated in FIGS. 8 to 10, the magnet 26E includes an outlet-side opening part 70c and an inlet-side opening part 70d, as the opening part 70 allowing a communication between the space 60 inside the magnet 26E and the outside of the magnet 26E.

The outlet-side opening part 70c is provided in a surface of the magnet 26E on the outer side in a radial direction crossing the axial direction of the rotor 10, that is, in the outer peripheral surface 100. The outer peripheral surface 100 is a surface opposite from the facing surface 74. The outlet-side opening part 70c is provided, for example, in an axial end portion of the magnet 26E on one side.

The inlet-side opening part 70d is provided in the magnet 26E so as to be isolated from the outlet-side opening part 70c. For example, the inlet-side opening part 70d is provided in the facing surface 74 of the magnet 26E. The inlet-side opening part 70d is provided, for example, in an axial end portion of the magnet 26E on the other side.

Note that such a form in which the inlet-side opening part 70d is provided in the facing surface 74 is one option, and the inlet-side opening part 70d may be provided at any position such as a position in an axial end face of the magnet 26E as long as the inlet-side opening part 70d is isolated from the outlet-side opening part 70c.

The fins 72 are provided inside the outlet-side opening part 70c and inside the inlet-side opening part 70d. Each of the fins 72 rectifies a flow of the heating medium moving through the outlet-side opening part 70c or a flow of the heating medium moving through the inlet-side opening part 70d. In addition, heat radiation of the fin 72 itself can also suppress temperature increase of the magnet 26E. Note that the fin 72 may be omitted.

In addition, part of the rotor body 20 corresponding to the outlet-side opening part 70c of the magnet 26E has a communication hole 110 that is continuous to the outlet-side opening part 70c. The communication hole 110 passes through the rotor body 20 and allows a communication between the outside of the rotor body 20 and the outlet-side opening part 70c.

When the rotation of the rotor 10 is stopped, the heating medium such as air is stagnated inside the magnet 26E. When the rotation of the rotor 10 is started, due to the circumferential rotation of the magnet 26E, a centrifugal force related to the rotation angular velocity of the magnet 26E and the own weight of the heating medium acts on the stagnated heating medium inside the magnet 26E. Since the outlet-side opening part 70c is provided in the outer peripheral surface 100 of the magnet 26E, the heating medium on which the centrifugal force acts is delivered to the outer side in the radial direction from the outlet-side opening part 70c. Thus, the heating medium inside the magnet 26E is delivered outside the magnet 26E through the outlet-side opening part 70c and is also delivered outside the rotor body 20 through the communication hole 110.

When the heating medium inside the magnet 26E is delivered to the outside through the outlet-side opening part 70c, the pressure inside the magnet 26E becomes negative pressure. In that way, the heating medium is sucked into the magnet 26E through the inlet-side opening part 70d.

In the above-described way, the heating medium is caused to flow inside the magnet 26E. Thus, the magnet 26E of this modification can also suppress, from the inside of the magnet 26E, temperature increase of the magnet 26E.

FIG. 11 is a perspective view illustrating one example of the configuration of a rotor 210 of a motor 200 of a modification. In the motor 200, mention and description of the stator will be omitted for convenience. The motor 200 is an inner-rotor motor in which the rotor 210 is disposed on the inner side relative to the stator.

The rotor 210 includes a rotor body 220, a rotating shaft 224, and a magnet 226. The rotor body 220 has a circular columnar shape. The rotating shaft 224 is fitted into the rotor body 220. The magnet 226 is provided on an outer peripheral surface of the rotor body 220.

The magnet 226 includes a lattice structure part 230 and an opening part 232. The lattice structure part 230 is provided inside the magnet 226. A space 234 is formed inside the magnet 226 by using the lattice structure part 230. The opening part 232 is provided in an axial end face of the rotor 210 and allows a communication between the space 234 inside the magnet 226 and the outside of the magnet 226.

The motor 200 including the rotor 210 can also allow the heating medium to flow inside the magnet 226. Thus, the motor 200 can also suppress, from the inside of the magnet 226, temperature increase of the magnet 226.

As described above, the motor 1 and the motor 200, regardless of whether an outrunner motor or an inner-rotor motor is adopted, can suppress temperature increase of the magnets 26 and 226.

Note that each of the modifications of an outrunner motor may be appropriately applied to an inner-rotor motor as in FIG. 11.

Although the embodiment of the disclosure has so far been described above with reference to the accompanying drawings, the embodiment is one option of embodiments of the disclosure. It is clear that those skilled in the art can conceive of various modifications or alterations within the scope of the claims, and it is to be understood that the modifications and alterations are naturally included in the technical scope of the embodiment of the disclosure.

According to the embodiment of the disclosure, temperature increase of a magnet can be suppressed.

1. A motor comprising:
a stator;
a rotor configured to rotate relative to the stator; and
a magnet provided for the rotor while facing the stator, wherein
the magnet has, at least inside the magnet, a space in which a heating medium is capable of flowing.

2. The motor according to claim 1, wherein
the space of the magnet is formed by forming at least an inside structure of the magnet into a lattice structure.

3. The motor according to claim 1, wherein
the magnet comprises
a facing surface facing the stator and covering the space inside the magnet, and
at least one opening part allowing a communication between the space inside the magnet and an outside of the magnet.

4. The motor according to claim 3, wherein
the magnet further comprises a fin,
the at least one opening part is provided in an end face of the magnet in an axial direction of the rotor, and
the fin extends from the at least one opening part in a direction inclined to the axial direction of the rotor.

5. The motor according to claim 3, wherein
the at least one opening part comprises
an outlet-side opening part provided in a surface of the magnet on an outer side in a radial direction crossing an axial direction of the rotor, and
an inlet-side opening part provided in the magnet so as to be isolated from the outlet-side opening part.
